(19) United States
(12) Patent Application Publication
(10) Pub. No.: US 2019/0081710 A1
(43) Pub. Date: Mar. 14, 2019

(54) WIRELESS COMMUNICATION SYSTEM, HOST DEVICE AND MOBILE DEVICE

(71) Applicants: LITE-ON ELECTRONICS (GUANGZHOU) LIMITED, GUANGZHOU (CN); Lite-On Technology Corporation, Taipei (TW)

(72) Inventors: Shiang-Hua Lin, Taipei (TW); Kuang-Yao Liao, Taipei (TW); Ping-Mao Lee, Taipei (TW); Hui-Hsuan Chou, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 16/038,187

(22) Filed: Jul. 18, 2018

(30) Foreign Application Priority Data
Sep. 12, 2017 (TW) 106213557

(51) Int. Cl. H04B 11/00

(52) U.S. Cl. CPC H04B 11/00; H04W 88/10

(57) ABSTRACT

A wireless communication system for transmitting energy in ultrasonic waves, a host device, and a mobile device are provided. The wireless communication system includes at least one host device and at least one mobile device. The host device each includes an ultrasonic energy transmitter and a wireless communication receiver. The host device transmits an energy signal in ultrasonic waves through the ultrasonic energy transmitter. The mobile device each includes an ultrasonic energy receiver and a wireless communication transmitter. The mobile device receives the energy signal in ultrasonic waves through the ultrasonic energy receiver and drives the wireless communication transmitter through the energy signal to transmit a communication signal to a field, such that the host device located in the field receives the communication signal.

### CROSS-REFERENCE TO RELATED APPLICATION

This application claims the priority benefit of Taiwan application serial no. 106213557, filed on Sep. 12, 2017. The entirety of the above-mentioned patent application is hereby incorporated by reference herein and made a part of this specification.

### BACKGROUND OF THE INVENTION

### Field of the Invention

The disclosure relates to a communication technique, and in particular, to a wireless communication system for transmitting energy in ultrasonic waves, a host device, and a mobile device.

### Description of Related Art

Due to management requirements (e.g., enhancing working efficiency of the hospital, information acquisition and provision, flow of patients and staff, etc.), there is now a need for managing entry/exit regulation and position tracking of the staff, patients, or mobile medical devices in the medical setting of current clinical institutes. Moreover, the clinical institutes are expecting more applications related to remote monitoring, smart clinical visit, medical information provision, etc. realized through relevant equipment.

However, when position tracking management equipment for the staff, patients, or mobile medical devices is deployed in the medical setting of clinical institutes, there is concern that electromagnetic waves of such equipment will cause impact on the human body or cause failure of medical equipment due to electromagnetic interference. In addition, safety concerns (e.g., accidents such as burning and power leakage) related to batteries should also be considered.

### SUMMARY OF THE INVENTION

The embodiments of the invention provide a wireless communication system for transmitting energy in ultrasonic waves, a host device, and a mobile device that avoid safety concerns related to a battery and eliminate interference of electromagnetic waves.

A wireless communication system for transmitting energy in ultrasonic waves according to an embodiment of the invention includes at least one host device and at least one mobile device. The host device each includes an ultrasonic energy transmitter and a wireless communication receiver. The host device transmits an energy signal in ultrasonic waves through the ultrasonic energy transmitter. The mobile device each includes an ultrasonic energy receiver and a wireless communication transmitter. The mobile device receives the energy signal in ultrasonic waves through the ultrasonic energy receiver and drives the wireless communication transmitter through the energy signal to transmit a communication signal to a field, such that the host device located in the field receives the communication signal.

A mobile device for receiving energy in ultrasonic waves according to an embodiment of the invention includes an ultrasonic energy receiver, a power storage device, and a wireless communication transmitter. The ultrasonic energy receiver receives an energy signal in ultrasonic waves. The power storage device is coupled to the ultrasonic energy receiver and stores a driving power provided by the energy signal. The wireless communication transmitter is coupled to the power storage device and is configured to receive the driving power and transmit a communication signal.

A host device for transmitting energy in ultrasonic waves according to an embodiment of the invention includes a wireless communication receiver, a host controller, and an ultrasonic energy transmitter. The wireless communication receiver is configured to receive a communication signal. The host controller is coupled to the wireless communication receiver and provides a control signal according to the communication signal. The ultrasonic energy transmitter is coupled to the host controller and transmits an energy signal in ultrasonic waves according to the control signal.

Accordingly, in the wireless communication system of the embodiments of the invention, the host device transmits the energy signal in ultrasonic waves to the mobile device. After the mobile device receives the energy signal in ultrasonic waves, the wireless communication transmitter in the mobile device is activated to transmit the communication signal to the host device located in the communication range. Then, the host device can learn the position of the mobile device and further perform positioning. Since it is possible to perform the operations of the wireless communication transmitter by using the energy transmitted in ultrasonic waves without disposing a battery in the mobile device, safety concerns related to the battery can be avoided. Moreover, by transmitting information through the Low Energy Bluetooth technique, the impact caused by electromagnetic waves on other medical equipment is further reduced or eliminated.

To provide a further understanding of the aforementioned and other features and advantages of the disclosure, exemplary embodiments, together with the reference drawings, are described in detail below.

### BRIEF DESCRIPTION OF THE DRAWINGS

FIG. 1 is a schematic diagram illustrating a wireless communication system according to an embodiment of the invention.

FIG. 2 is a schematic diagram illustrating the host device and the mobile device according to the embodiment of FIG. 1.

FIG. 3 is a schematic diagram illustrating a host device and a mobile device according to another embodiment of the invention.

### DESCRIPTION OF THE EMBODIMENTS

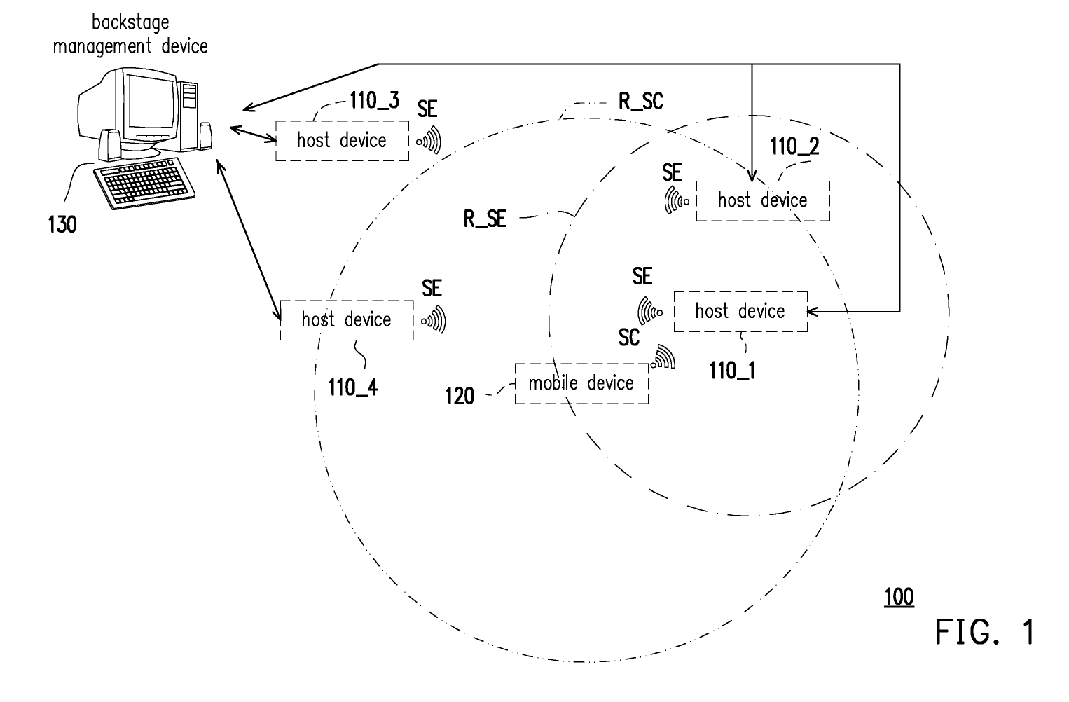

Referring to FIG. 1, FIG. 1 is a schematic diagram illustrating a wireless communication system according to an embodiment of the invention. A wireless communication system 100 in the embodiment of FIG. 1 is adapted to transmit energy in the form of ultrasonic waves. For clarity of description, in the present embodiment, the operations of the wireless communication system 100 are described with four host devices and one mobile device 120. The numbers of the host devices and the mobile devices of the invention may be one or more and are not specifically limited. The wireless communication system 100 of the present embodiment may include host devices 110_1, 110_2, 110_3, 110_4 and at least one mobile device 120. In the present embodiment, the host devices 110_1, 110_2, 110_3, 110_4 transmit an energy signal SE in ultrasonic waves. The mobile device 120 receives the energy signal SE in ultrasonic waves and transmits a communication signal SC to a field R_SC through the energy signal SE, such that the host devices 110_1, 110_2, 110_3, 110_4 located in the field R_SC can receive the communication signal SC transmitted by the mobile device 120.

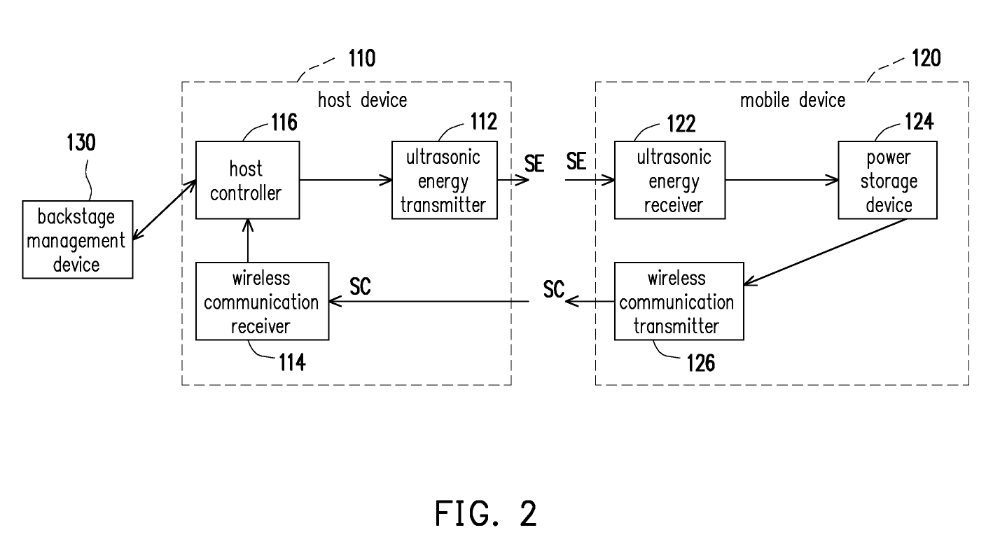

Referring to FIG. 2, FIG. 2 is a schematic diagram illustrating the host device and the mobile device according to the embodiment of FIG. 1. In the embodiment of FIG. 2, the host device 110 includes an ultrasonic energy transmitter 112 and a wireless communication receiver 114. The mobile device 120 each includes an ultrasonic energy receiver 122 and a wireless communication transmitter 126. The host device 110 may transmit the energy signal SE in ultrasonic waves through the ultrasonic energy transmitter 112.

In the present embodiment, the ultrasonic energy transmitter 112 may be an ultrasonic energy transmitting component including a bimorph, a resonant plate, and a dual input terminal. In the present embodiment, a control signal may be provided through the dual input terminal in the ultrasonic energy transmitter 112. The ultrasonic energy transmitter 112 may cause the bimorph to vibrate according to the control signal and transmit the energy signal SE in ultrasonic waves through the resonant plate.

The energy signal SE transmitted by the ultrasonic energy transmitter 112 of the host device 110 is a periodic energy signal SE. The ultrasonic energy transmitter 112 transmits the energy signal SE once per minute in ultrasonic waves periodically. The transmission time and the setting of periodic transmission of the energy signal SE may be adjusted by a person applying the present embodiment according to the requirement and are not specifically limited in the invention.

The mobile device 120 receives the energy signal SE in ultrasonic waves through the ultrasonic energy receiver 122 and drives the wireless communication transmitter 126 through the energy signal SE to transmit the communication signal SC to the field. In the present embodiment, the ultrasonic energy receiver 122 may be an ultrasonic energy receiving component including a bimorph, a resonant plate, and a dual output terminal. After the resonant plate of the ultrasonic energy receiver 122 receives the energy signal SE in ultrasonic waves, the energy signal SE is converted into a driving power through the bimorph and the dual output terminal to thereby drive the wireless communication transmitter 126.

In some embodiments, the driving power may be rectified through voltage rectification (e.g., by a rectifier) into a DC driving power. In some embodiments, the mobile device 120 may further store the driving power provided by the energy signal SE in a power storage device 124 coupled to the ultrasonic energy receiver 122 to thereby extend the driving time of the mobile device 120. The power storage device 124 may be implemented as a capacitor or may be implemented as another power storage component.

It is noted that the host device 110 and the mobile device 120 transmit the energy signal SE in a wireless and ultrasonic manner. Moreover, it is not necessary to configure the body of the mobile device 120 with an external power device for operation. Therefore, it is not necessary to design a charge contact point or a hole on the body of the mobile device 120, which prevents the danger of burning or power leakage of a battery and thus eliminates battery-related safety concerns.

In the present embodiment, transmission of the communication signal SC between the mobile device 120 and the host device 110 may be compatible with the Low Energy Bluetooth (BLE) protocol. Therefore, the communication between the mobile device 120 and the host device 110 conforms to regulations related to electromagnetic interference (EMI) in medical fields to avoid the invisible impact on the human body caused by electromagnetic waves and failure of medical equipment due to electromagnetic interference. The communication signal SC includes a universally unique identifier (UUID) of the mobile device 120 itself and a received signal strength indicator (RSSI).

After the mobile device 120 transmits the communication signal SC to the field, the host device 110 located in the field may receive the communication signal SC through the wireless communication receiver 114. The host device 110 may include a host controller 116 coupled to the wireless communication receiver 114 for providing the corresponding control signal according to the communication signal SC.

Referring to FIG. 1 again, it is noted that, generally, the transmission distance of the energy signal SE is about 3 meters, and the transmission distance of the communication signal SC is about 5 to 10 meters. Therefore, the transmission distance of the energy signal SE is smaller than the transmission distance of the communication signal SC. In other words, the field R_SC of the communication signal SC is larger than a transmission range R_SE of the energy signal SE.

In the embodiment of FIG. 1, after the host devices 110_1, 110_2, 110_4 receive the communication signal SC in the range of the field R_SC, the host devices 110_1, 110_2, 110_4 may determine the distance between the mobile device 120 corresponding to the UUID and the host devices 110_1, 110_2, 110_4 according to the UUID and the RSSI of the communication signal SC to perform a simple positioning on the mobile device 120.

For example, in the present embodiment, according to the communication signal, the host device 110_1 determines that the distance between the host device 110_1 itself and the mobile device 120 is smaller than a predetermined distance (e.g., 1.2 meters). This means that the mobile device 120 is very close to the host device 110_1. Accordingly, the host controller (not illustrated in FIG. 1) of the host device 110_1 provides the control signal. A field service corresponding to the mobile device 120 may be generated according to the control signal provided by the host device 110_1. The predetermined distance may be adjusted by a person applying the present embodiment according to the requirement and is not specifically limited in the invention. In some embodiments, the host controller of the host device 110_1 may further adjust the transmission cycle of the energy signal SE of the host device 110_1 (e.g., shortening the transmission cycle of the energy signal SE) through the provided control signal when the host device 110_1 determines that the distance between the host device 110_1 itself and the mobile device 120 is smaller than the predetermined distance.

As another example, the host devices 110_2, 110_4 determine that the distance between the host devices 110_2, 110_4 themselves and the mobile device 120 is larger than the predetermined distance, or the host device 110_3 does not receive the communication signal SC. This means that the mobile device 120 is not close enough to the host devices 110_2, 110_3, 110_4. Accordingly, the corresponding field services are not provided, or the transmission cycle of the energy signal SE of the host devices 110_2, 110_3, 110_4 is adjusted.

In the embodiment of FIG. 1, the wireless communication system 100 may further include a backstage management device 130. The backstage management device 130 may be coupled to the host devices 110_1, 110_2, 110_3, 110_4 in a wired or wireless manner and may provide the field service corresponding to the mobile device 120 according to the communication signal SC received by the host devices 110_1, 110_2, 110_3, 110_4. In the present embodiment, in addition to the simple definition for the position of the mobile device 120 based on the distance measurement method above, the backstage management device 130 may also receive the communication signal SC from the host devices 110_1, 110_2, 110_3, 110_4 to obtain more accurate positions of the mobile device 120 and record a movement path of the mobile device 120 based on positioning techniques such as a triangle centroid positioning method, a three-point positioning method, or another multiple-point positioning method. Moreover, the field service or applications corresponding to the mobile device 120 is provided according to the result of the positioning operation.

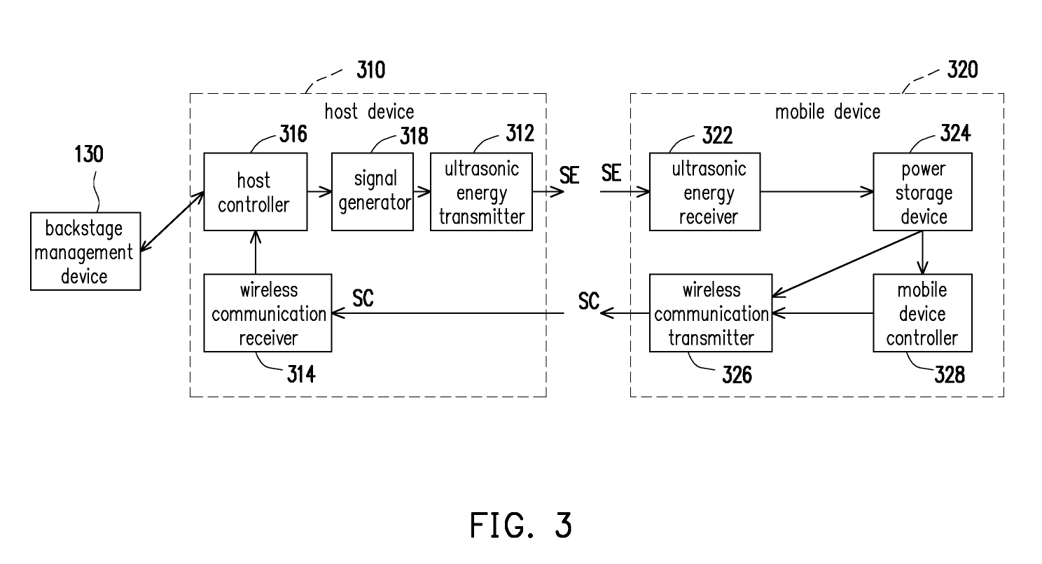

Referring to FIG. 3, FIG. 3 is a schematic diagram illustrating a host device and a mobile device according to another embodiment of the invention. The difference from FIG. 2 lies in that a host device 310 of the present embodiment further includes a signal generator 318. The wireless communication receiver 114 in FIG. 1 is the same as the wireless communication receiver 314 in FIG. 3. The signal generator 318 is coupled to a host controller 310 and an ultrasonic energy transmitter 312. A mobile device 320 further includes a mobile device controller 328. In the embodiment of FIG. 3, the host controller 316 of the host device 310 further configures a control signal to include host information of the host device 310 itself. After encoding the control signal including the host information, the host controller 316 transmits the encoded control signal to the signal generator 318. The signal generator 318 receives the control signal. After receiving the control signal, the signal generator 318 generates an energy signal SE including the host information according to the control signal and outputs the energy signal SE to the ultrasonic energy transmitter 312. Moreover, the ultrasonic energy transmitter 312 transmits the energy signal SE in ultrasonic waves. After the mobile device 320 receives the energy signal SE in ultrasonic waves through an ultrasonic energy receiver 322, the mobile device controller 328 coupled between a power storage device 324 and a wireless communication transmitter 326 is driven by a driving power to decode the driving power to obtain the host information, and controls the wireless communication transmitter 326 according to the obtained host information to determine to transmit the communication signal SC to the field. For example, the mobile device 320 may determine whether the mobile device 320 itself is present in a designated working area according to the host information. If the mobile device 320 is not in the designated working area, e.g., not on a designated floor, the mobile device 320 may not transmit the communication signal SC.

Next, actual applications of the wireless communication system in the medical field will be detailed. Referring to the embodiment of FIG. 1 again, in the actual application of the wireless communication system 100 in the medical field, the mobile device 120 may be an ID badge of the staff, a wristband worn by a patient to be treated, or a mobile medical device. The host devices 110_1, 110_2, 110_3, 110_4 may be disposed at designated positions by a person applying the present embodiment according to the requirement, such that at least one of the host devices 110_1, 110_2, 110_3, 110_4 or the backstage management device 130 can effectively position the mobile device 120 according to the communication signal to provide the field service to the mobile device 120.

In the actual application of the wireless communication system 100 in the medical field, the field service may be “a vital sign measurement system”, “an electronic medical kit”, “health education”, “remote monitoring and care”, “a nursing station push notification”, and “a smart clinical visit bulletin”. For example, if the medical field plans to provide the field service “health education” to the patient to be treated, when the patient to be treated enters the working area of “health education”, at least one of the host devices 110_1, 110_2, 110_3, 110_4 or the backstage management device 130 may determine whether to provide the field service of playing off-bed “health education” according to the wristband worn by the patient to be treated. Alternatively, if the patient to be treated is not leaving the ward, the host devices 110_1, 110_2, 110_3, 110_4 or the backstage management device 130 may determine whether to provide the field service of playing “health education” by the bed according to the wristband worn by the patient to be treated.

As another example, if the medical field plans to provide the field service “vital sign measurement system” to the patient to be treated, the patient to be treated, the staff, and the mobile medical device may enter the working area of “vital sign measurement system”, and at least one of the host devices 110_1, 110_2, 110_3, 110_4 or the backstage management device 130 may provide the field service of operating the “vital sign measurement system” on the patient to be treated according to the wristband worn by the patient to be treated, the ID badge worn by the staff, and the mobile medical device. Specifically, since the mobile medical device receives the energy signal SE from at least one of the host devices 110_1, 110_2, 110_3, 110_4, the mobile medical device may obtain the driving power provided by the energy signal SE to perform a low-power vital sign measurement operation.

As another example, the patient to be treated and the staff may enter the working area of the “nursing station push notification” and the “smart clinical visit bulletin”, and the host devices 110_1, 110_2, 110_3, 110_4 or the backstage management device 130 may determine whether to perform the bulletin service of “smart clinical visit bulletin” according to the wristband worn by the patient to be treated or the ID badge of the staff.

In summary of the above, in the wireless communication system of the embodiments of the invention, the host device transmits the energy signal in ultrasonic waves to the mobile device. After the mobile device receives the energy signal in ultrasonic waves, the wireless communication transmitter in the mobile device is activated to transmit the communication signal to the host device located in the communication range. The host device can then learn the position of the mobile device and further perform positioning. Accordingly, since it is possible to perform the operations of the wireless communication transmitter by using the energy transmitted in ultrasonic waves without disposing a battery in the mobile device, safety concerns related to the battery can be avoided. Moreover, by transmitting information through the Low Energy Bluetooth technique, the impact caused by electromagnetic waves on other medical equipment is further reduced or eliminated.

Although the invention is disclosed as the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A wireless communication system for transmitting energy in ultrasonic waves, comprising:
at least one host device comprising an ultrasonic energy transmitter and a wireless communication receiver, wherein the host device transmits an energy signal in ultrasonic waves through the ultrasonic energy transmitter; and
at least one mobile device comprising an ultrasonic energy receiver and a wireless communication transmitter, wherein the at least one mobile device receives the energy signal in ultrasonic waves from the at least one host device through the ultrasonic energy receiver and drives the wireless communication transmitter through the energy signal to transmit a communication signal to a field, such that the at least one host device located in the field receives the communication signal.

2. The wireless communication system according to claim 1, wherein the ultrasonic energy transmitter transmits the energy signal periodically.

3. The wireless communication system according to claim 1, wherein the communication signal comprises a universally unique identifier and a received signal strength indicator, and a transmission distance of the energy signal is shorter than a transmission distance of the communication signal.

4. The wireless communication system according to claim 1, wherein the host device further comprises:
a host controller, coupled to the wireless communication receiver, providing a control signal according to the communication signal.

5. The wireless communication system according to claim 4, wherein the host controller provides a field service according to the received communication signal.

6. The wireless communication system according to claim 4, wherein the host controller configures the control signal to comprise host information of the host device.

7. The wireless communication system according to claim 6, wherein the host device further comprises:
a signal generator, coupled to the host controller and the ultrasonic energy transmitter, the signal generator receiving the control signal generated by the host controller to generate the energy signal and outputting the energy signal to the ultrasonic energy transmitter.

8. The wireless communication system according to claim 6, wherein the mobile device further comprises:
a power storage device, coupled to the ultrasonic energy receiver, storing a driving power provided by the energy signal; and
a mobile device controller, coupled to the power storage device and the wireless communication transmitter, decoding the driving power to obtain the host information and controlling the wireless communication transmitter to transmit the communication signal to the field according to the host information.

9. The wireless communication system according to claim 1, further comprising:
a backstage management device, coupled to the host device, the backstage management device providing the field service corresponding to the mobile device according to the at least one communication signal received by the at least one host device.

10. The wireless communication system according to claim 1, wherein the wireless communication receiver and the wireless communication transmitter are compatible with Low Energy Bluetooth.

11. The wireless communication system according to claim 9, wherein the backstage management device performs a positioning operation according to the at least one communication signal received by the at least one host device and provides the field service corresponding to the mobile device according to a result of the positioning operation.

12. A mobile device for receiving energy in ultrasonic waves from at least one host device, the mobile device comprising:
an ultrasonic energy receiver receiving an energy signal in ultrasonic waves from the at least one host device; and
a wireless communication transmitter driven through the energy signal to transmit a communication signal to a field, such that the at least one host device located in the field receives the communication signal.

13. The mobile device according to claim 12, further comprising:
a power storage device, coupled to the ultrasonic energy receiver, storing a driving power provided by the energy signal; and
a mobile device controller, coupled to the power storage device and the wireless communication transmitter, decoding the driving power to obtain host information and controlling the wireless communication transmitter to transmit the communication signal to the field according to the host information.

14. The mobile device according to claim 12, wherein the wireless communication transmitter is compatible with Low Energy Bluetooth.

15. A host device for transmitting energy in ultrasonic waves to at least one mobile device, the host device comprising:
a wireless communication receiver located in a field and receiving a communication signal of the at least one mobile device; and
an ultrasonic energy transmitter transmitting an energy signal in ultrasonic waves to the at least one mobile device.

16. The host device according to claim 15, further comprising:
a host controller, coupled to the wireless communication receiver, providing a control signal according to the communication signal.

17. The host device according to claim 16, wherein the host controller obtains positioning information corresponding to the communication signal according to the received communication signal and provides a field service according to the positioning information.

18. The host device according to claim 16, wherein the host controller configures the control signal to comprise host information of the host device.

19. The host device according to claim 18, further comprising:
a signal generator, coupled to the host controller and the ultrasonic energy transmitter, the signal generator receiving the control signal generated by the host controller to generate the energy signal and outputting the energy signal to the ultrasonic energy transmitter.

20. The host device according to claim 15, wherein the wireless communication receiver is compatible with Low Energy Bluetooth.
